(19) United States
(12) Patent Application Publication
(10) Pub. No.: US 2003/0021357 A1
(43) Pub. Date: Jan. 30, 2003

(54) Method and apparatus of zero deflection

(76) Inventors: Victor Korol, Petach Tikva (IL); Eliav Zipper, Ramat Gan (IL); Ilan Barak, Kfar Saba (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 09/910,769

(22) Filed: Jul. 24, 2001

(51) Int. Cl. H04L 27/04

(52) U.S. Cl. 375/295

(57) ABSTRACT

Briefly, in accordance with one embodiment of the invention, a method of predicting zero crossing of a signal and deflecting the signal from an origin of a complex trajectory plane.

### BACKGROUND

In modern wireless communication systems such as cellular communication systems, radio transmitters in general and radio transmitters which may comprise a polar feedback loop, may transmit Radio Frequency (RF) signals at variable powers levels. The RF signals may have discontinuity in phase and may have variable amplitude. Zero crossing of the RF signal may cause discontinuity in phase. In order to enable the zero crossing of the signal the transmitter may need to incorporate wide dynamic range amplifier. The zero crossing may also cause degradation of the transmitter Adjacent Channel Power Ratio (ACPR) which is out of most cellular standard limits.

However, transmitters that enable to transmit RF signal which has phase zero crossing may involve the use of complicated circuitry that may increase the overall cost of the transmitter. In addition, transmitters that may comprise polar feedback loop may not be able to perform phase measurements in order to control the phase of the transmitter output signal. Thus, there is a continuing need for better ways of eliminating the phase zero crossing of the signal

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of a transmitter in accordance with an embodiment the present invention;

FIG. 2 is a schematic representation of signals that may be candidate of zero crossing in accordance with an embodiment of the present invention;

FIG. 3 is a flow chart of a method of zero deflecting in accordance with an alternative embodiment of the present invention;

FIG. 4 is a graph illustrating calculating of a deflection value in accordance with embodiments of the present invention; and

FIG. 5 is an exemplary illustrations of deflection windows which may be exploited by embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description which follow are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

In the following description and claims, the terms “chip”, “PN code”, and “zero crossing” along with their derivatives, may be used. It should be understood that these terms are not intent as synonyms for each other. The term “chip” may use to describe multiple sub-bits in a direct sequence spread spectrum technique. The direct sequence spread spectrum technique is a digital modulation technique in which a digital signal is spread over a wide frequency band so that it has a noise-like spectrum. This is done by breaking up each data bit into multiple sub-bits. Chips may also be referred to in this application as PN code bits (Pseudo Noise code bits). The term “zero crossing” may use to describe transitions of an amplitude and a phase of a signal through a zero amplitude level.

Unless specifically stated otherwise, as apparent from the following discussions, it is appreciated that throughout the specification discussions utilizing terms such as “processing”, “computing”, “calculating”, “determining”, “estimating” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories registers or other such information storage, transmission or display devices.

It should be understood that the present invention may be used in variety of applications. Although the present invention is not limited in this respect, the circuits and techniques disclosed herein may be used in many apparatus such as transmitters of a radio system. Transmitters intended to be included within the scope of the present invention include, by a way of example only, cellular radiotelephone transmitters, two-way radio transmitters, digital system transmitters, analog system transmitters and a like.

Type of cellular radiotelephone transmitters intended to be within the scope of the present invention including, although not limited to, Code Division Multiple Access (CDMA) and wide band CDMA (W-CDMA) cellular radiotelephone transmitters for transmitting spread spectrum signals. Time Division Multiple Access (TDMA) transmitters, Extended-TD)MA (E-TDMA) transmitters with a non-constant envelop digital modulation techniques, and the like.

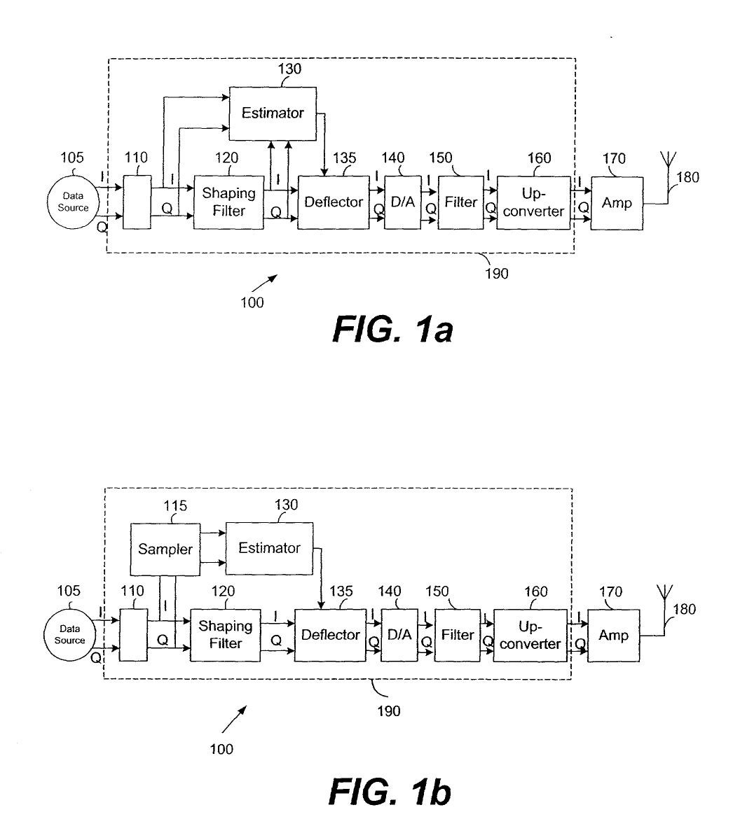

Turning to FIGS. 1a and 1b, a transmitter 100 in accordance with an embodiment of the invention is shown. The transmitter 100 includes a data source 105, a baseband block 190, an amplifier 170 and an antenna 180. The baseband block 190 may be a hardware device or may be implemented in software by a computer. An example of the baseband block 190 is a general computer which received signals from the data source 105, process the signals and output the processed signals to the amplifier 170 or a digital signal processor (DSP) for doing the same. The baseband block 190 comprise a channelization and spreading block 110, a pulse shaping filter 120, an estimator 130, a deflector 135, a digital to analog (DIA) converter 140, a reconstruction filter 150, an upconverter 160, and an antenna 180.

An example of the operation of transmitter 100 will be described now. In this particular example, transmitter 100 may be adapted to transmit spread spectrum signal that may include data structure of W-CDMA system or CDMA system or CDMA 2000 system or data structure of other spread spectrum system. However, in alternative embodiments of the invention, transmitter 100 may be adapted to transmit other types of cellular radiotelephone signals such as described above.

In operation, the data source 105 output a In Phase/Quadrature (I/Q) data stream that includes data symbols which include blocks of bits to the baseband block 190. Inside the baseband block 190, the channelization and spreading block 110 may be channelized and spread with a spreading technique that uses basic complex scrambling and Pseudo-Noise (PN) signals the data symbols for providing In-Phase (I) signal and Quadrature (Q) signal. In third generation (3G) cellular systems for example, W-CDMA, spreading technique such as Hybrid Phase Shift Keying (HPSK) which also known to the person skilled in the art as Orthogonal Complex Quadrature Phase Shift Keying (OCQPSK) may be used. However, other spreading techniques, for example, Offset Quadrature Phase shift Keying (OQPSK) and alike may be used. The output of the channelization and spreading module 110 are I and Q signals which may comprise PN code bits The PN code bits are also known to those skilled in the art of spread spectrum systems as chips. Although, the scope of the invention limited in this respect, in one embodiment of the invention, the I portion of the chips and Q portion of the chips may be input to the pulse shaping filter 120, The pulse shaping filter 120 may include filter to shape the I portion of the chips and a filter to shape the Q portion of the chips. Although, the scope of the invention limited in this respect, the I portion of the chips and the Q portion of the chips may be input to the estimator 130. Although, is should be understood that the scope and application of the present invention is in no way limited to these examples, the pulse shaping filter 120 may include a low pass filter. The low pass filter may limit the signal spectrum and may prevent an inter symbol interference. The output from the shaping filter 120 may be I/Q samples at double chip rate or higher. The I/Q samples may be input to estimator 130 and to the deflector 135. Although, the scope of the invention limited in this So respect, in other embodiment of the invention, the estimator 130 may receives at least two consecutive chips and at least two consecutive samples S, and Sₙ₊₁. The samples Sₙ and Sₙ₊₁ may be sampled at each chip interval. The estimator 130 is adapted to predict an occurrence of a predetermined amplitude level in an in-phase and quadrature phase (I/Q) complex trajectory The estimator 130 may use this prediction to determine if zero crossing of the trajectory complex plane possible. For candidate signals of zero crossing, the estimator 130 outputs corrective parameters according to at least two consecutive blocks of bits (chips) to the deflector 135, The estimator 130 may be adapted to provide the trajectory corrective parameters according to estimated distance between the origin of the complex trajectory plane to the I/Q complex trajectory. Although, the scope of the invention limited in this respect, the data of trajectory corrective parameters may be adjusted according to adjustable deflection window. The deflection window may be any type of a weighting window. FIG. 5 shows types of weighting windows which may be exploited with embodiments of the invention. Although it is not limited to this example, the adjustable deflection window may be a Kaiser window 500. However, other types of windows such as a Bartlett window 501, Blackman window 502, Chebyshev window 503, Hamming window 504 or Hanning window 505 may be used. The deflector 135 deflects the signals from the origin of the complex trajectory plane according to the estimator prediction by adding trajectory corrective parameters to the samples surrounding samples Sₙ and Sₙ₊₁. Turning to FIG. 1B. another embodiment of the present invention, a sampler 115 may be added to receive chips Cₙ and Cₙ₊₁ to provide samples Sₙ and Sₙ₊₁ of I and Q to the estimator 130. Although the invention is not limited to this embodiment, the estimator 130 may not receive I and Q signals from the output of the shaping filter 120. Referring now to the embodiments of FIGS. 1a and 1b, the I and Q signals from the deflector 135 may be inputt to DIA 140. As shown, the D/A 140 may convert the data of the I and Q signals into I and Q analog signals. The I and Q analog signals may input to the reconstruction filter 150. The reconstruction filters 150, may include for example, a low pass filter that filters harmonic distortion from the I analog signal and a low pass filter that filters harmonic distortion from the I analog signal.

Furthermore, the reconstruction filter 150 may filter a distortion of signal replication that created as result of the sampling rate by the sampler 115. from the I and Q analog signals. In other embodiment of the invention, the reconstruction filters 150 may be replaced by other types of filters or may not be needed in the case of sampling rate which may not result a signal replication.

The I and Q analog signals may be input to the upconverter 160. As shown, the upconverter 160 combines the I and Q analog signal and up converts the combined signal into a radio frequency (RF) signal. The amplifier 170 amplifies the RF signal and outputs the amplified RF signal to antenna 180. The antenna 180 may be adapted to the frequency of the RF signal and transmit the amplified RF signal.

Although, the scope of the present invention is not limited to above described embodiments of the invention, the modules channeilizion and spreading 110, shaping filter 120, D/A 140, reconstruction filter 150, upconverter 160 and the amplifier 170 may be standard modules which may be used in spread spectrum transmitters such as CDMA, W-CDMA or CDMA 2000. However, other known implementations which may know to the skilled person in the art, may be used. For example, the amplifier 170 may include an outphasing amplifier with a reactive termination.

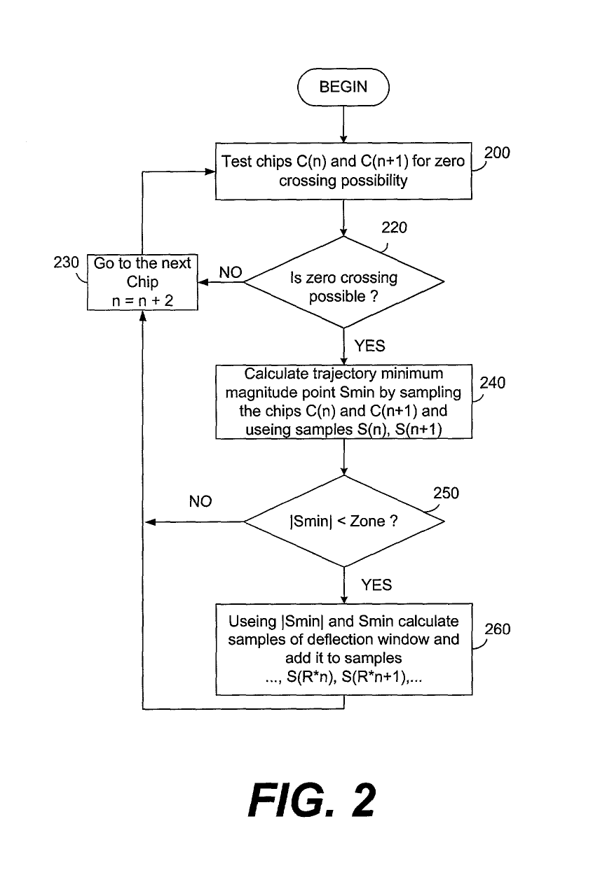

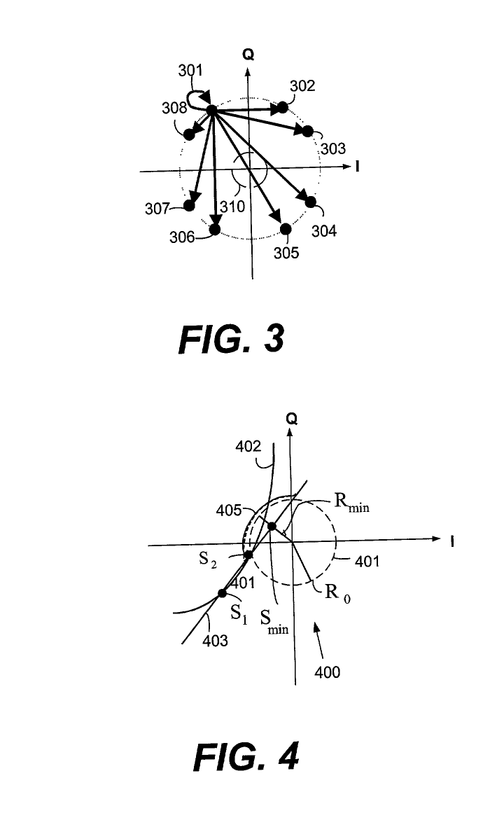

Although embodiments of the present invention are not limited to this respect, the method for deflecting signal which is a candidate for zero crossing will be described now with references to FIGS. 2, 3 and 4. Turning now to FIG. 2, a flow chart of a method of deflection a signal from the origin of the complex plane is described. The method starts with testing two consecutive chips C(n) and C(n+1) for zero crossing possibility, as is shown in block 200. Testing of zero crossing possibility may be based on an a priori knowledge of the type of the transmitter and of the type of modulation. FIG. 3 is an example of possible transitions of signals on I/Q trajectory complex plane of two code transmitter. For two-code transmitter only 3 of 8 possible transitions may be candidates for zero crossing. As is shown in FIG. 3 vectors 301, 302, 303, 304, 305, 306, 307 and 308 are the possible transitions. Transitions 304, 305 and 306 may be candidate for zero crossing. The dotted circle 310 shows a zone of possible zero crossing. The information of the transition may be processed from Dedicated Physical Data Channel (DPDCH) and Dedicated Physical Control Channel (DPCCH) bits of the chips C(n) and C(n+1). Turning back to FIG. 2, the method proceeds with testing if zero crossing possible for at least one of the 3 possible transitions, as is shown in 220. If none of the possible transitions was found to be a candidate for zero crossing, then the next pair of chips C(n+1) and C(n+2) may be processed, as is shown at block 230. If candidate transitions for zero crossing found, then the following algorithm for calculating trajectory minimum magnitude point (Smin) by using at least two consecutive data samples S(n) and S(n+1) of the elected signal may be used, as is shown at 240. The samples S(n) and S(n+1) are obtained at the chips C(n) and C(n+1) and may be dependent on the sampling rate R.

$$wherein R = \frac{Samples}{Chips} .$$

It should be understood that other methods for calculating the trajectory minimum magnitude may be used.

The method for calculating trajectory minimum magnitude Sₘᵢₙ, will be described with reference to FIG. 4. FIG. 4 shows the deflection of an elected signal 403 on an 110 complex trajectory plane 400. FIG. 4 further shows a complex trajectory curve of the signal 402, a deflected signal (dotted curve) 405, a zero zone 401 and a zero zone radius R₀. Although it not limited to this respect, an a priori knowledge of minimum point of the trajectory allows to define the level and the direction of shifting the elected signal 403 from the zero zone 401 of the IQ complex trajectory plane 400. The calculation of Sₘᵢₙ based on S(R*n) and S(R*n+1) filtered samples of chip C(n). Following drawing shows a part of IQ trajectory and S(4*n), S(4*n+1) and 5 ml, points. For the sake of simplicity S(R*n), S(R n+1) are called S1 and S2 respectively. An example of S1 and S2 is shown with FIG. 4.

Although the invention is not limited to the below formulas, an example of a linear estimation of the distance between the trajectory and the origin of the I/Q complex plane 400 will be described below.

In this example

S_{Δ}=S₁−S₂ (1)

is the difference vector between S₁ and S₂.

Linear estimation of minimum trajectory point Smin may be calculated by (2)

$${S}_{min} = {S}_{1} - {S}_{Δ} \cdot \frac{{I}_{1} \cdot {I}_{Δ} + {Q}_{1} \cdot {Q}_{Δ}}{{I}_{Δ}^{2} + {Q}_{Δ}^{2}} \qquad ( 2 )$$

The magnitude of Sata is used to calculate the magnitude of a shift 406 that should be applied to the trajectory.

Rₘᵢₙ=|Sₘᵢₙ|=\sqrt{Iₘᵢₙ²+Qₘᵢₙ²} (3)

An alternative equation to equation (3) may be an approximated formula for Sₘᵢₙ magnitude calculation as shown below.

$$R min ≅ \vert {S}_{min} \vert = \vert {I}_{min} \vert + \frac{\vert {Q}_{min} \vert}{2} - \frac{\vert {Q}_{min} \vert}{8} {I}_{min} \geq {Q}_{min} \\ R min ≅ \vert {S}_{min} \vert = \vert {Q}_{min} \vert + \frac{\vert {I}_{min} \vert}{2} - \frac{\vert {I}_{min} \vert}{8} {Q}_{min} \geq {I}_{min} \qquad ( 4 )$$

The approximation (3) may introduce an error up to about 6.5% maximum.

In some embodiments of the invention, the flowing method of obtaining test samples Sₙ and Sₙ₊₁ may be used. In general, two or more test samples Sₙ, Sₙ₊₁, Sₙ₊₂

shaping filter 120. In order to obtain additional samples at arbitrary times offset from the chips, a filter that includes the same filter shape of pulse shaping filter 120 and the sampling rate of Half-Nyquist rate (equal to chip rate) may be used The samples of such a filter are chosen at desired time offset from its center providing the same offset of the output samples on the signal's trajectory.

The Half-Nyquist rate filter may yield one test sample at predefined time offset from the chip Cₙ.

Although the scope of the invention limited in this respect, an example of a method for providing the above described filter with the receiving chips will be described now. Let us formally define Half-Nyquist rate filter and the filtering of the chips. Assume continuous impulse response of the filter is Fₙ(t). Than sampled filter response is: Fₙ(n)=Fₙ(n/Rc+T_{offset}) where Rc is the chip rate and T_{offset} is the sampling offset.

Obtaining the test sample Sₙ associated with chip Cₙ is done by convolving sequence of chips with the filter

$$\begin{matrix}{S}_{n} = {C}^{′} : \\ {S}_{n} = C ⊕ {Fs}_{δ} = {\sum }_{i = - N}^{N} C ( i + n ) \cdot {Fs}_{δ} ( i ) - \\ where N is the length of the filter in chips .\end{matrix}$$

where N is the length of the filter in chips.

Turning back to FIG. 2, if |Sₘᵢₙ| falls in the zero zone 401, step 250, deflection of the trajectory is be performed. Although the scope of the invention is not limited to this example, a soft deflection window may be added to IQ samples surrounding samples S_{(R*n)}, S_{(R*n+1)}, as is shown in 260. The deflection window may be centered around sample S The length of the window may include 7 samples (2 chip duration). The samples of the window may be calculated by using, for example, base Kaiser window. However, other windows such as Rectangle, Triangle, Hanning, Hamming, Blackman, Lanczos, Tukey and the like may be used. An example of the window samples may be samples w=[w₋₃, w₋₂, w₋₁, w₀, w₁, w₂, w₃] and complex scaling factor −SC_{FACT}. The deflection window W which is used with the above example may be a complex sample sequence.

The deflection window may also be described by the following equations.

W(i,q)=SC_{FACT}(i,q)·w (5)

scaling of the unity scalar window to the actual values for I and Q.

Wherein SC_{FACT} can be calculated using |Sₘᵢₙ|, Sₘᵢₙ and R_{c}. as it is shown with equation (6).

$${SC}_{FACT} = {S}_{min} \cdot ( \frac{{R}_{0}}{\vert {S}_{min} \vert} - 1 ) \qquad ( 6 )$$

However, the window scaling calculation may be done by using a look up table (LUT) as is shown by equation (7)

SC_{FACT}=S_{dir}·LUT(round |Sₘᵢₙ|). (7)

Wherein round, rounds Sₘᵢₙ value into integer value; and

Wherein S_{dir} is rotated vector S by +90° or −90°.

Rotation direction may be chosen so that signs of real and imaginary parts of S_{dir} become the same as signs of Sₘᵢₙ other words, the direction of trajectory shift may be normal to the trajectory and may not point to the origin. If we define S_{dir}=I_{dir}+jQ_{dir} and S=I+jQ than

$$\begin{matrix}{I}_{dir} = \vert {Q}_{Δ} \vert \cdot sign ( {I}_{min} ) \\ {Q}_{dir} = \vert {I}_{Δ} \vert \cdot sign ( {Q}_{min} )\end{matrix} - finding the direction vector of scaling window \qquad ( 8 )$$

finding the direction vector of scaling window

The final step is deflecting the trajectory as is shown by equation (9)

S_{final}(m)=S(K+m)+W(m)

Wherein K is the offset from the beginning of the processed data signal and

m is the offset from the beginning of the window.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus comprising:
an estimator adapted to predict an occurrences of a predetermined amplitude level in an in-phase and quadrature phase (I/Q) complex trajectory plane; and
a deflector which is adapted to deflect the I/Q complex trajectory from an origin of the I/Q complex trajectory plane according to an estimator prediction.

2. The apparatus of claim 1, wherein the deflector is adapted to receive samples of an I/Q data stream and deflect the I/Q complex trajectory of the I/Q data stream according to I/Q complex trajectory correctives parameters.

3. The apparatus of claim 2, wherein the estimator is adapted to receive at least two consecutive symbols of the I/Q data stream and determined whether or not to provide the I/Q complex trajectory correctives parameters according to at least two consecutive symbols.

4. The apparatus of claim 3, wherein the estimator adapted to provide the trajectory corrective parameters according to estimated distance between the origin of the complex trajectory plane to the I/Q complex trajectory.

5. The apparatus of claim 4, further comprising:
an adjustable deflection window adapted to a weighting window.

6. A portable communication device comprising:
an estimator adapted to predict an occurrences of a predetermined amplitude level in an in-phase and quadrature phase (I/Q) complex trajectory plane.

7. The portable communication device of claim 6 further comprising:
a deflector which is adapted to deflect the I/Q complex trajectory from an origin of a complex trajectory plane according to the estimator prediction.

8. The portable communication device of claim 7, wherein the deflector is adapted to receive samples of I/Q data stream and deflects the I/Q complex trajectory of the I/Q data stream according to I/Q complex trajectory correctives parameters.

9. The portable communication device of claim 8, wherein the estimator adapted to receive at least two consecutive symbols of the I/Q data stream and to decide whether or not to provide the I/Q complex trajectory correctives parameters according to at least two consecutive symbols.

10. The portable communication device of claim 9, wherein the estimator adapted to provide the trajectory corrective parameters according to adjustable deflection window.

11. The portable communication device of claim 10, wherein the adjustable deflection window is adapted to a weighting window.

12. The portable communication device of claim 11, further comprises a data source for providing the I/Q data stream and an antenna.

13. The portable communication device of claim 11, further comprises an outphasing radio frequency (RF) amplifier with a reactive termination.

14. An apparatus comprising;
an estimator adapted to predict an occurrences of a predetermined amplitude level in an in-phase and quadrature phase (I/Q) complex trajectory plane which be deflected from an origin of a complex trajectory plane according to the estimator prediction.

15. The apparatus of claim 15 further comprising:
a channelization and spreading block which is operably coupled to a pulse shaping filter and to the estimator wherein the pulse shaping filter is operably coupled to the deflector;
an digital to analog converter which receive signals from the deflector and output signals to a filter; and
an upconverter which receives signals from the filter and adapted to upconvert the signals into a radio frequency signals.

16. The apparatus of claim 15, further comprises a sampler which receives an in-phase and quadrature (I/Q) phase data stream from the channelization and spreading block and adapted to provide samples of I/Q data stream to the estimator.

17. A method comprising:
predicting occurrence of a predetermined amplitude level in an in-phase and quadrature phase (I/Q) complex trajectory plane.

18. The method of claim 18 further comprising:
deflecting an I/Q complex trajectory from an origin of a complex trajectory plane according to a prediction.

19. The method of claim 18, wherein deflecting comprises:
deflecting the I/Q complex trajectory of the I/Q data stream according to I/Q complex trajectory corrective parameters.

20. The method of claim 19 wherein predicting comprises:
deciding whether or not to provide to I/Q complex trajectory corrective parameters according to a data of at least two consecutive symbols of the I/Q data stream.

21. The method of claim 20, further comprising:
providing the trajectory corrective parameters according to adjustable deflection window.

22. An article comprising: a storage medium having stored thereon instructions, that, when executed by a computing platform, results in:
predicting occurrence of a predetermined amplitude level in an in-phase and quadrature phase (I/Q) complex trajectory plane; and
deflecting an I/Q complex trajectory from an origin of a complex trajectory plane according to a prediction.

23. The article of claim 22, wherein the instructions of deflecting result in:
deflecting the I/Q complex trajectory of the I/Q data stream according to I/Q complex trajectory corrective parameters.

24. The article of claim 23 wherein instructions of predicting result in:
deciding whether or not to provide to I/Q complex trajectory corrective parameters according to a data of at least two consecutive symbols of the I/Q data stream.

25. The article of claim 24, wherein instructions further result in:
providing the trajectory corrective parameters according to estimated distance between the origin of the complex trajectory plane to the I/Q complex trajectory.
